(19) United States
(12) Patent Application Publication
(10) Pub. No.: US 2007/0117570 A1
(43) Pub. Date: May 24, 2007

(54) Scheduling apparatus and method in a communication system

(75) Inventors: Seol-Hyun Noh, Suwon-si (KR); Jae-Hee Cho, Seoul (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/593,394

(22) Filed: Nov. 6, 2006

(30) Foreign Application Priority Data
Nov. 4, 2005 (KR) 2005-105509

(51) Int. Cl. H04Q 7/20

(52) U.S. Cl. 455/452.2; 370/208; 370/465

(57) ABSTRACT

Provided is a scheduling method in a communication system. In the scheduling method, a Base Station (BS) gathers and stores its channel quality information from each of a plurality of Mobile Stations (MSs), and checks a Multi-Input Multi-Output (MIMO) scheme previously established between the BS and each MS. The BS selects a link table corresponding to each MS among a plurality of link tables previously included in the BS according to the checked MIMO scheme, and performs scheduling according to the stored channel quality information of each MS and the selected link table.

### PRIORITY

This application claims the benefit under 35 U.S.C. § 119(a) of an application filed in the Korean Intellectual Property Office on Nov. 4, 2005 and assigned Serial No. 2005-105509, the contents of which are incorporated herein by reference.

### BACKGROUND OF THE-INVENTION

1. Field of the Invention

The present invention relates generally to a scheduling apparatus and method in a communication system, and in particular, to a scheduling apparatus and method in a communication system using a Multiple-Input Multiple-Out (MIMO) scheme.

2. Description of the Related Art

In the next generation communication system, research is being conducted to provide high-speed services having various Qualities of Service (QoS) to users. Particularly, in the future communication system, active research is being carried out to support high-speed services capable of guaranteeing mobility and QoS for a Broadband Wireless Access (BWA) communication system such as a Wireless Local Area Network (WLAN) system and a Wireless Metropolitan Area Network (WMAN) system. An Institute of Electrical and Electronics Engineers (IEEE) 802.16a/d communication system and an IEEE 802.16e communication system are the typical BWA communication systems.

The IEEE 802.16a/d communication system and an IEEE 802.16e communication system employ Orthogonal Frequency Division Multiplexing (OFDM)/Orthogonal Frequency Division Multiple Access (OFDMA) to support a broadband transmission network for a physical channel of the WMAN system. The IEEE 802.16a/d communication system takes into account only the situation where a Subscriber Station (SS) is fixed, i.e. a single cell structure where mobility of the SS is never considered. However, the IEEE 802.16e communication system takes into account mobility of the SS in the IEEE 802.16a communication system. The SS having mobility will be referred to as a “Mobile Station (MS).”

The wireless channel environment in the next generation communication system, unlike a wired channel environment, suffers from data loss due to a data transmission error caused by factors such as multi-path interference, shadowing, propagation attenuation, time-varying noise, interference, fading, etc. In order to reduce the information loss, various error-control techniques are used according to channel characteristic. Further, in order to prevent unstable communication due to fading, a diversity scheme is used. The diversity scheme can be roughly divided into a time diversity scheme, a frequency diversity scheme, and an antenna diversity scheme. The antenna diversity scheme, or a space diversity scheme, uses multiple antennas. In particular, a MIMO scheme implemented with a plurality of reception antennas and a plurality of transmission antennas can be divided into a transmit diversity scheme and a spatial multiplexing scheme as a modulation scheme, and the transmit diversity scheme includes various modulation schemes.

FIG. 1 illustrates a communication system using a general MIMO scheme. For convenience, it will be assumed herein that the communication system shown in FIG. 1 includes M transmission antennas and N reception antennas.

Referring to FIG. 1, a Base Station (BS) 101 transmits data to an MS 103 having N reception antennas via its M transmission antennas. Channels between the transmission antennas of the BS 101 and the reception antennas of the MS 103 are represented by an N×M channel matrix H as in Equation (1).

$$[ \begin{matrix}{h}_{11} & {h}_{12} & ⋯ & {h}_{1 M} \\ {h}_{21} & {h}_{22} & ⋯ & {h}_{2 M} \\ ⋮ & ⋮ & ⋰ & ⋮ \\ {h}_{N 1} & {h}_{N 2} & ⋯ & {h}_{NM}\end{matrix} ] \qquad ( 1 )$$

In Equation (1), a channel h_{N1} indicates a channel between a first transmission antenna of the BS 101 and an N^{th} reception antenna of the MS 102, and a channel h_{NM} indicates a channel between an M^{th} transmission antenna of the BS 101 and an N^{th} reception antenna of the MS 103.

The MIMO scheme is a Space-Time Coding (STC) scheme, and the STC scheme transmits a signal coded with a predetermined coding scheme using a plurality of transmission antennas to extend a time-domain coding scheme to a space-domain coding scheme, thereby achieving a lower error rate. With reference to FIGS. 2A to 2D, a description will now be made of a MIMO communication system using the STC scheme.

FIGS. 2A to 2D illustrate data transmission based on an STC scheme in a MIMO communication system. Specifically, FIG. 2A shows a communication system with 2 transmission antennas, and FIGS. 2B to 2D show a communication system with 4 transmission antennas.

Referring to FIGS. 2A to 2D, the communication system codes data symbols to be transmitted by a coding scheme used in the MIMO communication system defined in the standard of the IEEE 802.16 communication system using a specific coding scheme, and then transmits the coded symbols via their associated transmission antennas.

In the communication system, a BS includes a scheduler for efficiently allocating a channel for each of a plurality of MSs, and determining a Modulation and Coding Scheme (MCS) level of the channel. That is, the scheduler allocates a channel according to the amount of data to be transmitted to each MS and Channel Quality Information (CQI), for example, Carrier-to-Interference and Noise Ratio (CINR), fed back from each of the MSs, and determines an MCS level of the channel.

For example, in a communication system using a Single-Input Single-Output (SISO) scheme, a scheduler of a BS determines a Quadrature Phase Shift Keying (QPSK) modulation scheme as an MCS level if a CINR fed back from each MS is 5 dB, determines a 16-ary Quadrature Amplitude Modulation (16QAM) scheme for CINR=10 dB, and determines a 64QAM scheme for CINR=20 dB. Because the BS of the SISO communication system transmits data to one reception antenna included in each MS via one transmission antenna, the number of transmission antennas used for transmitting data to each of the MSs is constant. Therefore, the scheduler of the BS allocates a channel according to the amount of data to be transmitted to each MS and a CINR fed back from each of the MSs, and determines an MCS level of the channel.

With reference to FIG. 3, a description will now be made of scheduling in the MIMO communication system. FIG. 3 is a block diagram illustrating a structure of a scheduling apparatus of a BS in a general MIMO communication system.

Referring to FIG. 3, in the scheduling apparatus, if scheduling information 310-1 to 310-N of N MSs is delivered to a scheduler 321 in a Media Access Control (MAC) layer processor 320, the scheduler 321 allocates a channel for each MS according to the scheduling information 310-1 to 310-N of the MSs, and determines an MCS level of the allocated channel. The scheduling information 310-1 to 310-N includes data queue information fields 311-1 to 311-N where information on the amount of data to be transmitted to each MS is included, QoS parameter fields 313-1 to 313-N where QoS parameters are included, and CQI fields 315-1 to 315-N where CQIs, for example, CINRs, fed back from the MSs are included, respectively.

That is, the scheduler 321 allocates a channel to each MS according to the received scheduling information 310-1 to 310-N of the MSs, determines an MCS level of the allocated channel, and then delivers the determined MCS level to an encoder 331 of a physical (PHY) layer processor 330. The encoder 331 channel-encodes the data of corresponding MSs determined by the scheduler 321 according to an MCS level determined depending on a CQI of each MS, and then delivers the channel-coded data to a radio frequency (RF) processor 333. Then the RF processor 333 performs RF processing on the data, and then transmits the RF-processed data via a plurality of transmission antennas 341, 343 and 345.

In this way, the scheduler 321 of the BS in the MIMO communication system determines a specific MCS level according to the information included in the scheduling information 310-1 to 310-N of MSs, i.e. a CINR fed back from each MS and the amount of data to be transmitted to each MS. Here, the scheduler 321 determines the MCS level on the assumption that the number of channels between the BS and each MS is equal. For example, in the case where a BS has 4 transmission antennas, an MS1 has 2 reception antennas, and an MS2 has 4 reception antennas, even though the number of channels between the BS and the MS1 is different from the number of channels between the BS and the MS2, the scheduler 321, assuming that the number of channels between the BS and the MS1 is equal to the number of channels between the BS and the MS2, allocates channels according to the amount of data to be transmitted to the MS1 and the MS2 and CINRs fed back from the MS1 and MS2, and determines MCS levels of the channels.

As described above, in the MIMO communication system, as the number of reception antennas included in each MS is different, the number of channels between the BS and each MS can be different, and the number of transmission antennas used for transmitting data to each MS among the transmission antennas of the BS can also be different according to data reception capability of reception antennas included in each MS and decoding performance of each MS. That is, a MIMO scheme established between the BS and each MS is different. As described above, however, the scheduler in the general MIMO communication system has an undesirable attribute of not taking into account the difference in the MIMO scheme between the BS and each MS. In other words, in the MIMO communication system, the number of channels between transmission and reception antennas, i.e. the number of reception antennas of each MS, is different, and the number of transmission antennas of the BS, used for transmitting data to each MS, is different according to decoding performance of each MS and reception capability of the reception antennas. Because the number of channels between the transmission antennas of the BS and the reception antennas of each MS is different, there is a need for a scheduling scheme that takes into account the different MIMO scheme between the BS and each MS.

### SUMMARY OF THE INVENTION

It is, therefore, an object of the present invention to provide a scheduling apparatus and method in a communication system.

It is another object of the present invention to provide a scheduling apparatus and method in a MIMO communication system.

It is yet another object of the present invention to provide an apparatus and method for performing scheduling according to a MIMO scheme established between a BS and each MS.

According to one aspect of the present invention, there is provided a scheduling method in a communication system. The scheduling method includes: gathering and storing, by a base station (BS), its channel quality information from each of a plurality of mobile stations (MSs), and checking a Multi-Input Multi-Output (MIMO) scheme previously established between the BS and each MS; selecting a link table corresponding to each MS among a plurality of link tables previously included in the BS according to the checked MIMO scheme; and performing scheduling according to the stored channel quality information of each MS and the selected link table.

According to another aspect of the present invention, there is provided a scheduling apparatus in a communication system. The scheduling apparatus includes a controller for gathering and storing channel quality information from each of a plurality of mobile stations (MSs), and including the stored channel quality information of each MS in scheduling information; a determiner for checking a Multi-Input Multi-Output (MIMO) scheme previously established between a base station (BS) and each MS, and including an index of the checked MIMO scheme in the scheduling information; and a scheduler for selecting a link table corresponding to each MS among a plurality of previously provided link tables according to the index included in the scheduling information, and performing scheduling according to the selected link table and the channel quality information included in the scheduling information.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a communication system using a general MIMO scheme;

FIGS. 2A to 2D illustrates data transmission based on an STC scheme in a MIMO communication system;

FIG. 3 is a block diagram illustrating a structure of a scheduling apparatus of a BS in a general MIMO communication system;

FIG. 4 is a block diagram illustrating a structure of a scheduling apparatus in a MIMO communication system according to the present invention; and

FIG. 5 is a flowchart illustrating an operation of a scheduling apparatus in a MIMO communication system according to the present invention.

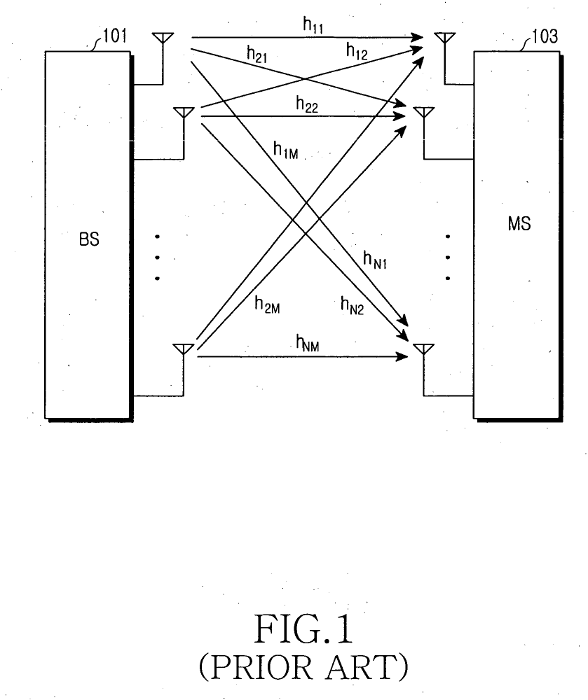

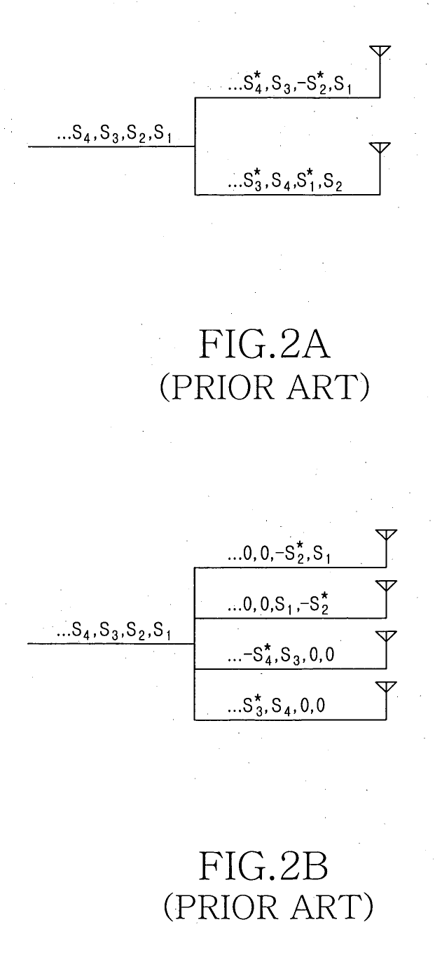

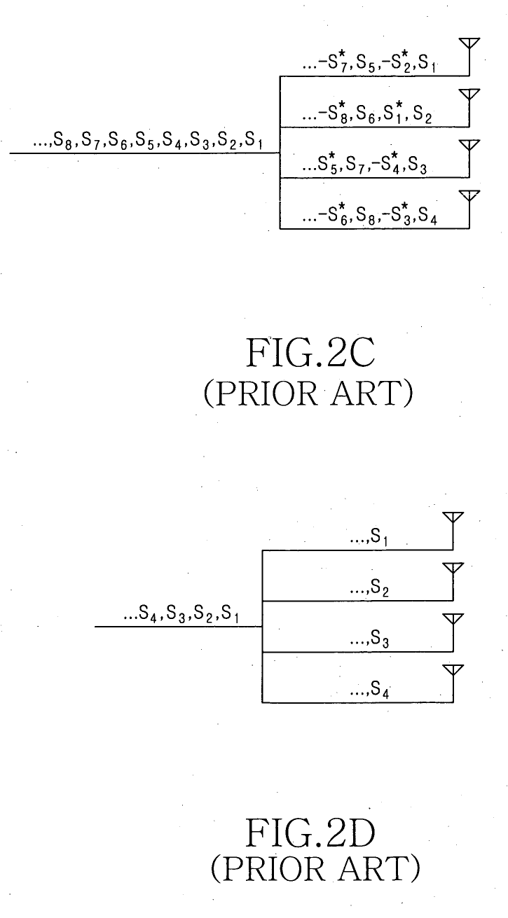

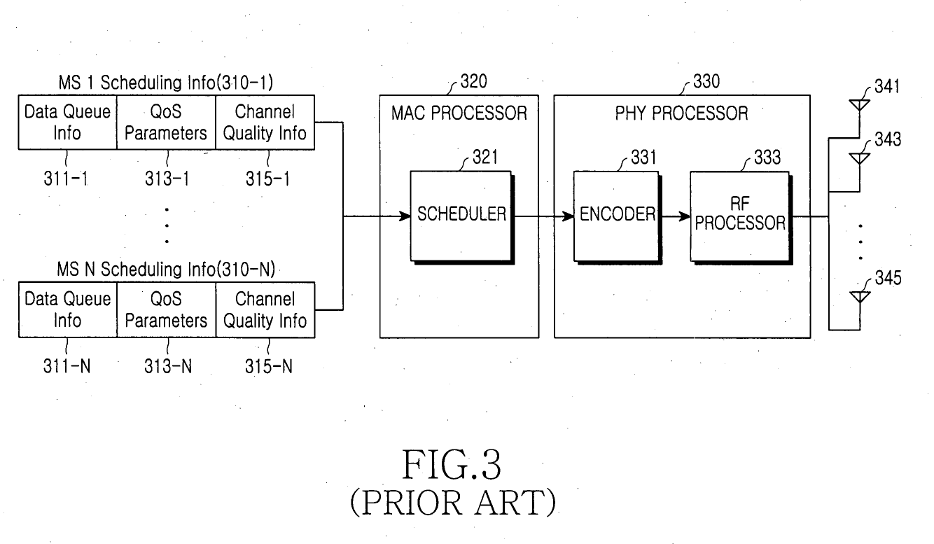

### DETAILED DESCRIPTION OF THE PREFERRED EMBODIMENTS

The preferred embodiments of the present invention will now be described in detail with reference to the annexed drawings. In the following description, a detailed description of known functions and configurations incorporated herein has been omitted for clarity and conciseness.

The present invention provides a scheduling apparatus and method in a communication system. The present invention provides a scheduling apparatus and method in a communication system using a Multi-Input Multi-Output (MIMO) scheme. In addition, the present invention provides a scheme in which when a scheduler included in a transmitter, for example, a Base Station (BS), including a plurality of transmission antennas, determines a bandwidth, for example, the number of subchannels, necessary for transmitting downlink data to each receiver, for example, each Mobile Station (MS), or allocates a channel, the scheduler performs scheduling depending on a link table predetermined based on a MIMO scheme established between each MS and the BS, Channel Quality Information (CQI) fed back from each MS, and information on the data to be transmitted to each MS. Herein, the scheduler can be included in the BS as described above, or included in an upper layer of the BS, for example, a BS controller.

In addition, the present invention provides a scheme for determining a Modulation and Coding Scheme (MCS) level of a channel depending on the link table, CQI, and data information. Herein, there are different link tables corresponding to the MIMO schemes established between the BS and each MS. For example, if there are 10 MIMO schemes established between the BS and each MS in the communication system, there are 10 link tables, and the link tables are managed by the BS. That is, the BS includes link tables corresponding to each of all MIMO schemes available between the BS and each MS, and if the scheduler is included in a BS upper layer, the link tables are included in the BS upper layer.

The present invention, a scheduler included in a BS already includes link tables established according to the MIMO scheme, and the scheduler selects a link table according to CQI fed back from each MS, the amount of data to be transmitted to each MS, and the MIMO scheme established between the BS and each MS, and performs scheduling using the selected link table. Further, in the present invention, the BS already includes link tables established according to the MIMO scheme between the BS itself and each MS as described above, and gathers and stores the CQI, for example, Carrier-to-Interference and Noise Ratio (CINR), reported by each MS every frame.

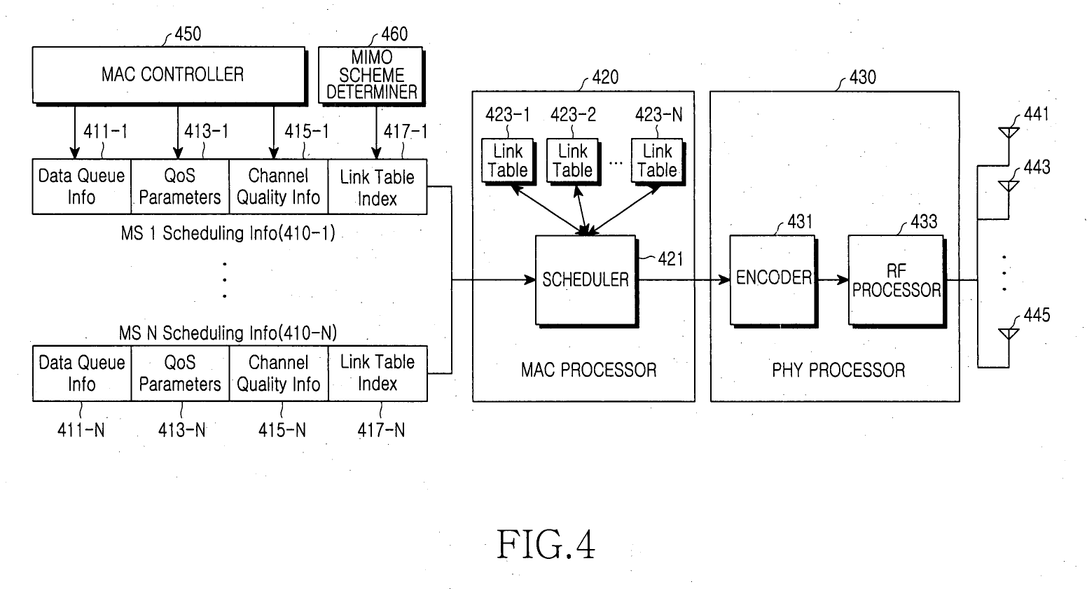

FIG. 4 is a block diagram illustrating a structure of a scheduling apparatus in a MIMO communication system according to the present invention. Referring to FIG. 4, the scheduling apparatus includes a Media Access Control (MAC) layer processor 420, a Physical (PHY) layer processor 430, a MAC controller 450, a MIMO scheme determiner 460, and a plurality of transmission antennas 441, 443 and 445.

If it is assumed that the number of MSs receiving a service from the BS is N, i.e. there are N MSs of MS1 to MSN, the data to be transmitted to the MSs is delivered to their associated queues. If the data to be transmitted to the MSs is delivered to their associated queues in this way, queue information of the data is included in data queue information fields 411-1 to 411-N of scheduling information 410-1 to 410-N of the MSs. That is, as the information of each data queue to which data to be transmitted to each MS is delivered is included in the data queue information fields 411-1 to 411-N, the information on the data to be transmitted to each MS, for example, the information on the amount of data to be transmitted to each MS, is included in the scheduling information 410-1 to 410-N of the MSs.

Further, the BS includes information on Quality of Service (QoS) parameters, which is information on QoS provided to each MS, in a corresponding one of QoS parameter fields 413-1 to 413-N of the scheduling information 410-1 to 410-N of the MSs. The BS, as described above, gathers and stores CQI fed back from each MS every frame, and the stored CQIs, for example, CINRs, fed back from the MSs every frame are included in CQI fields 415-1 to 415-N of the scheduling information 410-1 to 410-N of the MSs.

When the BS provides service to each of the MSs, a MIMO scheme was already established between the BS and each MS, and the BS checks the established MIMO scheme to provide the service to the MSs. An index of each link table corresponding to the checked MIMO scheme is included in link table index fields 417-1 to 417-N of the scheduling information 410-1 to 410-N of the MSs. That is, a corresponding MIMO scheme has already been established between the BS and each MS, and the BS includes a link table according to the established MIMO scheme. If the MIMO scheme corresponding to each MS is checked, the BS includes an index of a link table corresponding to the checked MIMO scheme in a corresponding one of the link table index fields 417-1 to 417-N of the scheduling information 410-1 to 410-N of the MSs.

Herein, data queue information, QoS parameters, and CQIs of the MSs are included, by the MAC controller 450, in the data queue information fields 411-1 to 411-N, the QoS parameter fields 413-1 to 413-N, and the CQI fields 415-1 to 415-N among the fields of the scheduling information 410-1 to 410-N of the MSs. That is, the MAC controller 450 gathers and stores the data queue information and QoS parameter of the data to be transmitted to each MS, and the CQI fed back from each MS, and then includes the stored CQI in a corresponding one of the scheduling information 410-1 to 410-N of the MSs.

The link table indexes are included in the link table index fields 417-1 to 417-N by the MIMO scheme determiner 460. The MIMO scheme determiner 460 determines the MIMO scheme established between the BS and each MS, and includes an index of the link table corresponding to the determined MIMO scheme in the corresponding scheduling information 410-1 to 410-N of the MSs.

If the scheduling information 410-1 to 410-N of the MSs with the foregoing information included in the corresponding fields is input to a scheduler 421 of the MAC layer processor 420, the scheduler 421 selects a link table included therein according to the input scheduling information. If N MIMO schemes are established between the BS and the N MSs, the scheduler 421 previously includes N link tables 423-1 to 423-N, and selects a link table corresponding to the link table index included in the scheduling information 410-1 to 410-N of the MSs according to the established MIMO scheme.

The scheduler 421 allocates a channel depending on CQI fed back from each MS every frame, information on the data to be transmitted to each MS, and the selected link table, all of which are included in the scheduling information 410-1 to 410-N, and determines an MCS level of the channel depending on the link table, CQI, and data information. More specifically, the scheduler 421 determines the MCS level depending on the CQI, for example, CINR, fed back by each MS every frame, and the selected link table.

For example, if the number of transmission antennas of a BS is 2 and the number of reception antennas of an MS is 2, indicating a 2×2 MIMO scheme, and a CINR is 5 dB, a scheduler selects a link table corresponding to the 2×2 MIMO scheme, and determines an MCS level for CINR=5 dB in the selected link table. For example, if it is assumed that an MCS for 2×2 MIMO scheme and CINR=5 dB in the selected link table is 16-ary Quadrature Amplitude Modulation (16QAM) ¼, the scheduler determines an MCS level of 16QAM ¼. In addition, for 4×4 MIMO scheme and CINR=5 dB, the scheduler selects a link table corresponding to the 4×4 MIMO scheme, and determines an MCS level for CINR=5 dB in the selected link table. For example, if it is assumed that an MCS for 4×4 MIMO scheme and CINR=5 dB in the selected link table is Quadrature Phase Shift Keying (QPSK) ½, the scheduler determines an MCS level of QPSK ½.

The scheduler 421 calculates the possible amount of data transmitted per channel or subchannel depending on the CQI and the selected link table. Thereafter, the scheduler 421 determines priority of each MS, i.e. determines an MS to which it will transmit data according to priority of each MS determined through a scheduling priority rule, taking into account the CINR and the average amount of data transmitted to each MS, and calculates a bandwidth or channel necessary for data transmission for the corresponding MS using the possible amount of data transmitted per channel and the amount of transmission data, included in the data queue information fields 411-1 to 411-N of the scheduling information 410-1 to 410-N.

In addition, the scheduler 421 allocates a bandwidth or channel of one frame, allocates all bandwidths or channels allocable in one frame by repeating the foregoing process until it allocates the channels to all MSs to which it will transmit data, or allocates channels to all MSs to which it will transmit data, thereby securing efficient channel allocation.

An encoder 431 of the PHY layer processor 430, as described above, channel-encodes data of the corresponding MS determined by the scheduler 421 according to a coding scheme of an MCS level determined based on the CQI of the corresponding MS and the selected link table, and then delivers the channel-coded data to an undepicted mapper. The mapper maps the input data according to a mapping scheme of the MCS level determined by the scheduler 421, modulates the mapped data using a modulator, and then provides the modulated data to a Radio Frequency (RF) processor 433. The RF processor 433 performs RF processing on the received signal, and transmits the RF-process signal to each BS via the transmission antennas 441, 443 and 445. For example, if the scheduler 421 determines an MCS level of 16QAM ¼, a coding rate of the channel coding scheme is ¼ and a mapping scheme of the mapper is 16QAM.

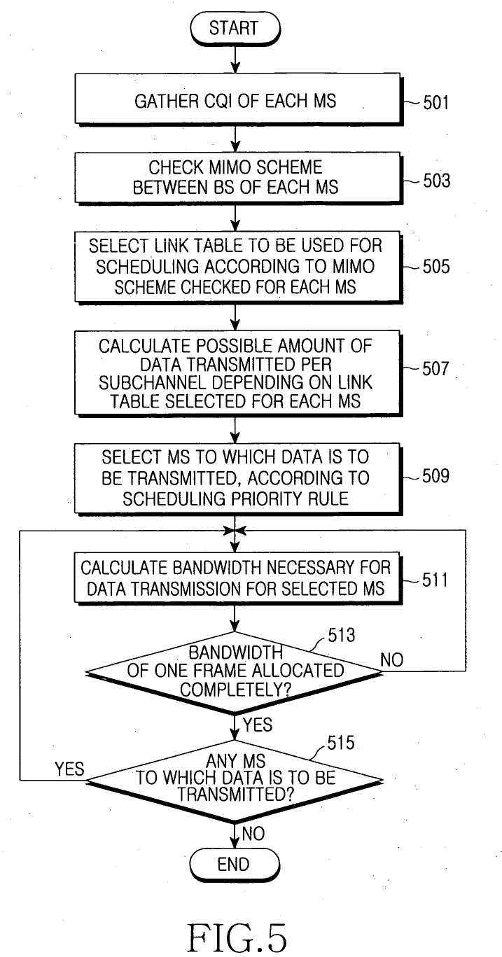

FIG. 5 is a flowchart illustrating an operation of a scheduling apparatus in a MIMO communication system according to the present invention. Referring to FIG. 5, in step 501, the scheduling apparatus gathers CQI fed back from each MS every frame, and stores the gathered CQI, for example, CINR, of each MS. In step 503, a MIMO scheme is previously established between a BS and each MS as described above, and the scheduling apparatus checks the established MIMO scheme to provide a service to each MS, and then proceeds to step 505. Here, the scheduling apparatus determines an index of the link table corresponding to the checked MIMO scheme.

In step 505, the scheduling apparatus selects a link table to be used for scheduling, according to the checked MIMO scheme. That is, the scheduling apparatus already includes link tables corresponding to the MIMO scheme established between the BS and each MS, and selects a link table to be used for scheduling among the link tables according to an index of the link table determined based on the MIMO scheme. If N MIMO schemes are established between the BS and the N MSs, the scheduling apparatus includes N link tables corresponding to the established MIMO schemes, and selects a link table corresponding to the checked MIMO scheme. Further, in step 505, the scheduling apparatus determines an MCS level depending on the selected link table.

If the number of transmission antennas of a BS is 2 and the number of reception antennas of an MS is 2, indicating a 2×2 MIMO scheme, and a CINR is 5 dB, the scheduling apparatus selects a link table corresponding to the 2×2 MIMO scheme, and determines an MCS level for CINR=5 dB in the selected link table. If it is assumed that an MCS for 2×2 MIMO scheme and CINR=5 dB in the selected link table is 16QAM ¼, the scheduling apparatus determines an MCS level of 16QAM ¼. In addition, for 4×4 MIMO scheme and CINR=5 dB, the scheduling apparatus selects a link table corresponding to the 4×4 MIMO scheme, and determines an MCS level for CINR=5 dB in the selected link table. If it is assumed that an MCS for 4×4 MIMO scheme and CINR=5 dB in the selected link table is QPSK ½, the scheduling apparatus determines an MCS level of QPSK ½.

Thereafter, in step 507, the scheduling apparatus calculates the possible amount of data transmitted per channel or subchannel depending on the selected link table. In step 509, the scheduling apparatus determines priority of each MS according to a scheduling priority rule, taking into account the CINR and the average amount of data transmitted to each MS, and selects an MS to which it will transmit data according to the determined priority of each MS. In step 511, the scheduling apparatus calculates a bandwidth or channel necessary for data transmission to the selected MS. That is, the scheduling apparatus calculates a bandwidth or channel necessary for data transmission according to the possible amount of data transmitted per channel or subchannel, calculated in step 507, and the amount of data to be transmitted to the MS selected in step 507.

In step 513, the scheduling apparatus determines whether all bandwidths or channels of one frame have been allocated. If it is determined that all the bandwidths have been allocated, the scheduling apparatus determines in step 515 whether there are any more MSs to which it will transmit data. If it is determined that there is no MS to which it will transmit data, the scheduling apparatus ends the scheduling operation. However, if it is determined in step 513 that there are remaining allocable bandwidths or channels in one frame, or if it is determined in step 515 that there is any MS to which it will allocate a channel for data transmission, the scheduling apparatus returns to step 511.

As can be understood from the foregoing description, the present invention provides a scheduling scheme corresponding to a MIMO scheme established between a BS and each MS in a MIMO communication system, thereby efficiently allocating a channel for each MS and determining an optimal MCS level. As a result, the data transmission efficiency of the system can be maximized.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A scheduling method in a communication system, comprising the steps of:
gathering and storing, by a Base Station (BS), channel quality information from each of a plurality of Mobile Stations (MSs), and checking a Multi-Input Multi-Output (MIMO) scheme previously established between the BS and each MS;
selecting a link table corresponding to each MS among a plurality of link tables previously included in the BS according to the checked MIMO scheme; and
performing scheduling according to the stored channel quality information of each MS and the selected link table.

2. The scheduling method of claim 1, wherein the link tables previously included in the BS are provided according to the MIMO scheme previously established between the BS and each MS.

3. The scheduling method of claim 1, wherein the step of performing scheduling according to the channel quality information and the link table comprises selecting an MS to which the BS will transmit data according to the channel quality information and the link table, allocating a channel for the selected MS, and determining a Modulation and Coding Scheme (MCS) level of the allocated channel.

4. The scheduling method of claim 3, wherein the step of selecting an MS to which the BS will transmit data comprises selecting the MS according to a scheduling priority rule for every frame in which the channel quality information is gathered and stored.

5. A scheduling apparatus in a communication system, comprising:
a controller for gathering and storing channel quality information from each of a plurality of Mobile Stations (MSs), and including the stored channel quality information of each MS in scheduling information;
a determiner for checking a Multi-Input Multi-Output (MIMO) scheme previously established between a Base Station (BS) and each MS, and including an index of the checked MIMO scheme in the scheduling information; and
a scheduler for selecting a link table corresponding to each MS among a plurality of previously provided link tables according to the index included in the scheduling information, and performing scheduling according to the selected link table and the channel quality information included in the scheduling information.

6. The scheduling apparatus of claim 5, wherein the scheduler includes a plurality of link tables according to a MIMO scheme previously established between the BS and each MS.

7. The scheduling apparatus of claim 5, wherein the scheduler selects an MS to which data will be transmitted according to the channel quality information and the link table, allocates a channel for the selected MS, and determines a Modulation and Coding Scheme (MCS) level of the allocated channel.

8. The scheduling apparatus of claim 7, wherein the scheduler selects the MS to which data will be transmitted according to a scheduling priority rule for every frame in which the channel quality information is gathered and stored.

9. The scheduling apparatus of claim 5, wherein the controller gathers and stores channel quality information from each MS every frame.

10. The scheduling apparatus of claim 5, wherein the scheduling information has a field including the channel quality information, a field including an index of the link table, a field including information on the data to be transmitted to each MS, and a field including a Quality-of-Service (QoS) parameter of the BS.
